(19) United States
(12) Patent Application Publication
(10) Pub. No.: US 2009/0080646 A1
(43) Pub. Date: Mar. 26, 2009

(54) Method And Architecture For Parallel Calculating Ghash Of Galois Counter Mode

(76) Inventor: Chih-Hsu Yen, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/135,210

(22) Filed: Jun. 9, 2008

Related U.S. Application Data
(63) Continuation-in-part of application No. 11/858,906, filed on Sep. 21, 2007.

(30) Foreign Application Priority Data
Jan. 22, 2008 (TW) 097102402

(51) Int. Cl. H04L 9/28; G06F 7/00

(52) U.S. Cl. 380/28; 708/492

(57) ABSTRACT

Disclosed is a method and architecture for parallel calculating GHASH of Galois Counter Mode (GCM), which regards the additional authenticated data A and the ciphertext C defined in the GCM as a single data M with an input order of a sequence M₁M₂ . . . Mₘ₋₁, and arranges the final output of the GHASH into a combination of the sequence M₁M₂ . . . Mₘ₋₁ and the hash key H. Then, the combined form for the final output is further divided into two odd and even parallel calculating parts. According to the two parallel calculating parts and the hash key H, the final output of the GHASH operation is calculated. This invention may calculate the additional authenticated data A and the ciphertext C in parallel. It may also calculate the even-order input data and odd-order input data in parallel.

### CROSS REFERENCE

This is a continuation-in-part application for the application Ser. No. 11/858,906 filed on Sep. 21, 2007.

### FIELD OF THE INVENTION

The present invention generally relates to a method and architecture for parallel calculating GHASH of Galois Counter Mode (GCM), applicable to GCM mode.

### BACKGROUND OF THE INVENTION

Galois Counter Mode (GCM) is an operation mode for the authenticated encryption block cipher system. The main feature of GCM is that GCM is fast, and provides confidentiality and integrity, and GCM is often applied to high speed transmission environment.

The data encryption of GCM uses the CTR mode, and the authentication uses a GHASH function based on Galois Field (GF). The authenticated encryption has four inputs, namely, secret key K, initialization vector IV, plaintext P, and additional authenticated data (AAD) A. P is divided into 128-bit blocks, expressed as {P₁, P₂, . . . , P*ₙ}, and A is divided into 128-bit blocks, expressed as {A₁, A₂, . . . , A*ₘ}, where blocks P*ₙ and A*ₘ are less than 128 bits. The authentication and encryption has two outputs, namely, ciphertext C and authentication tag T. Outputs C and T are obtained through the authenticated encryption operation.

GHASH function is an operation of GCM. The function has three inputs, and generates a 128-bit hash value. The three inputs are A, C and H, where H is the value obtained through the secret key K to encrypt the all-zero block. The following equation describes the output Xᵢ in i-th step of GHASH function.

$${X}_{i} = \{ \begin{matrix}0 & for i = 0 \\ ( {X}_{i - 1} ⊕ {A}_{i} ) \cdot H & for i = 1 , … , m - 1 \\ ( {X}_{m - 1} ⊕ ( {A}_{m}^{*} ‖ {0}^{128 - v} ) ) \cdot H & for i = m \\ ( {X}_{i - 1} ⊕ {C}_{i - m} ) \cdot H & for i = m + 1 , … , m + n - 1 \\ ( {X}_{m + n - 1} ⊕ ( {C}_{n}^{*} ‖ {0}^{128 - u} ) ) \cdot H & for i = m + n \\ ( {X}_{m + n} ⊕ ( len ( A ) ‖ len ( C ) ) ) \cdot H & for i = m + n + 1\end{matrix} \qquad ( 1 )$$

where Aᵢ is the additional authenticated data, Cᵢ is the ciphertext, ν is the bit length of block A*ₘ, u is the bit length of C*ₙ, ⊕ is the addition of GF(2¹²⁸), the multiplication is defined in GF(2¹²⁸), len (A) is the bit length of A, len(C) is the bit length of C, and len(A)∥len(C) is to concatenate the bit lengths into a 128-bit value.

U.S. Patent Publication No. 2006/0126835 disclosed a high-speed GCM-AES block cipher apparatus and method applicable to Ethernet passive optical network (EPON) environment for providing data encryption and decryption, authentication or simple packet authentication. As shown in FIG. 1, the GCM-AES includes a key expansion module 110, an 8-round CTR-AES block cipher module 130, a 3-round CTR-AES block cipher module 150, and a GF(2¹²⁸) multiplication module 170.

GCM is adopted by IEEE 802.1ae (MACsec) standard. If MACsec function is added to the router, switch or bridge, high processing power for encryption and decryption computing is required, and the GCM hardware must be able to achieve the gigabit or even tens of gigabits processing speed. If a plurality of GCM hardware is used to achieve the high processing speed, the hardware cost would be prohibitive. Therefore, a high-speed GCM hardware architecture can achieve the same object with less hardware cost.

### SUMMARY OF THE INVENTION

The disclosed exemplary embodiments in accordance with the present invention may provide a method and architecture for parallel calculating GHASH of Galois Counter Mode (GCM). The GHASH function has three inputs, namely, additional authenticated data A and ciphertext C defined in the GCM, and HASH key H of the GHASH function.

In an exemplary embodiment, the disclosed is directed to a method for parallel calculating GHASH of GCM, for providing applications of data confidentiality, comprising: treating the additional authenticated data A and ciphertext C as a single data M with an input order of a sequence M₁M₂ . . . Mₘ₋₁, and arranging the final output Xₘ₋₁ of the GHASH operation into a combination of the sequence M₁M₂ . . . Mₘ₋₁ and the power of the hash key H, where m−1 being the block length of said single data M, m being an integer larger than 1; dividing the combined form for the final output Xₘ₋₁ into two parallel calculating parts; and computing the final output of the GHASH operation according to the two parallel calculating parts and the hash key H.

In another exemplary embodiment, the disclosed is directed to an architecture for parallel calculating GHASH of GCM, for providing applications of data encryption, The architecture comprises three multipliers, four registers, and three multiplexers. The three multipliers calculate two parallel calculating parts and H² value, respectively. One of the four registers stores H value and H² value at two different clocks, another register stores a Z matrix value of H and H² at two different clocks, and two remaining registers store intermediate values of said two parallel calculating parts. The three multiplexers make different selections through control of different control signals. After calculating the two parallel calculating parts and selecting H through a Galois Field addition ⊕, the HASH value of said GHASH function is obtained.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary schematic view of GCM-AES block encryption apparatus.

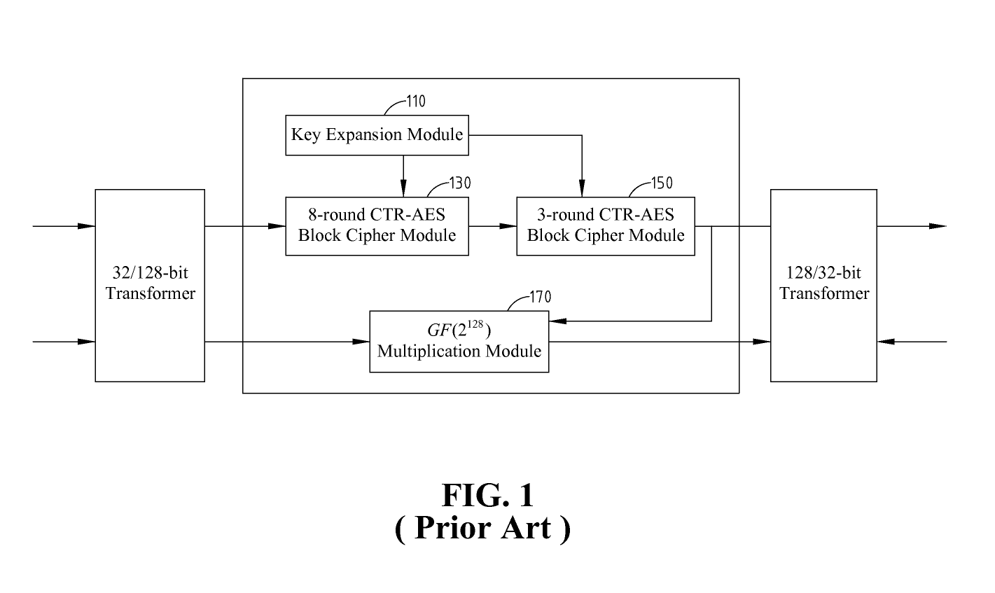

FIG. 2 shows an exemplary flowchart of the method for parallel calculating GHASH of GCM, consistent with certain disclosed embodiments.

FIG. 3 shows a schematic view of an exemplary architecture for parallel calculating GHASH of GCM, consistent with certain disclosed embodiments.

FIG. 4 shows a schematic view of another exemplary architecture for parallel calculating GHASH of GCM, consistent with certain disclosed embodiments.

### DETAILED DESCRIPTION OF THE PREFERRED EMBODIMENTS

In equation (1), GHASH function has three inputs, which are the additional authenticated data A, ciphertext C and HASH key H defined in GCM specification. If the application symbols, such as Ai, Ci, len(A)∥len(C), are not used, and the three inputs are considered as a single input data M, and the total block length of the data set as m−1, where m is an integer larger than 1, output Xi of the i-th step of GHASH function of equation (1) may be rewritten as follows:

$${X}_{i} = \{ \begin{matrix}0 & for i = 0 \\ ( {X}_{i - 1} ⊕ {M}_{i} ) \cdot H & for i = 1 , … , m - 1\end{matrix} \qquad ( 2 )$$

Equation (2) may be expanded to obtain the final output Xₘ₋₁ of GHASH function as follows:

Xₘ₋₁=M₁H^{m-1}⊕M₂H^{m-2}⊕M₃H^{m-3}⊕ . . . ⊕Mₘ₋₂H²⊕Mₘ₋₁H (3)

where the data input sequence is M₁M₂ . . . Mₘ₋₁.

When m−1 is an even number, the exponential of H is divided into odds and evens, and equation (3) may be written as:

$${X}_{m - 1} = \underbrace{( {M}_{1} {H}^{m - 1} ⊕ {M}_{3} {H}^{m - 3} ⊕ … ⊕ {M}_{m - 4} {H}^{4} ⊕ {M}_{m - 2} {H}^{2} )}_{{X}_{E}} ⊕ \underbrace{( {M}_{2} {H}^{m - 3} ⊕ {M}_{4} {H}^{m - 5} ⊕ … {M}_{m - 3} {H}^{2} ⊕ {M}_{m - 1} )}_{{X}_{O}} H \qquad ( 4 )$$

where X_{E} is the sum of the related values of M₂ᵢ₋₁ items, and X_{O} is the sum of the related values of M₂ᵢ items, and 1≦i≦m−1.

Similarly, when m−1 is an odd number, equation (3) may be written as:

$${X}_{m - 1} = \underbrace{( {M}_{1} {H}^{m - 2} ⊕ {M}_{3} {H}^{m - 4} ⊕ … ⊕ {M}_{3} {H}^{2} ⊕ {M}_{m - 1} )}_{{X}_{O}} H ⊕ \underbrace{( {M}_{2} {H}^{m - 2} ⊕ {M}_{4} {H}^{m - 4} ⊕ … ⊕ {M}_{m - 4} {H}^{4} ⊕ {M}_{m - 2} {H}^{2} )}_{{X}_{E}} \qquad ( 5 )$$

where X_{E} is the sum of the related values of M₂ᵢ items, and X_{O} is the sum of the related values of M₂ᵢ₋₁ items, and 1≦i≦m−1.

By rearranging equation (4) and equation (5), final output Xₘ₋₁ of GHASH function may be simplified in the form of X_{O}H+X_{E}, where X_{O} is all the items of H with odd exponential, and X_{E} is all the items of H with even exponential. X_{O} and X_{E} have the same computational structure, and may be both written in the form of Xᵢ=(Mᵢ⊕Xᵢ₋₁)H². Therefore, they may be implemented with two identical pieces of hardware. In other words, the odd/even data may be calculated in parallel. It is worth noting that the exponentials of H corresponding to m−1 being even and m−1 being odd are different. This type of using even/odd input in parallel may simplify the computation steps to (m+n)/2 steps. Therefore, the processing speed is increased by two-fold.

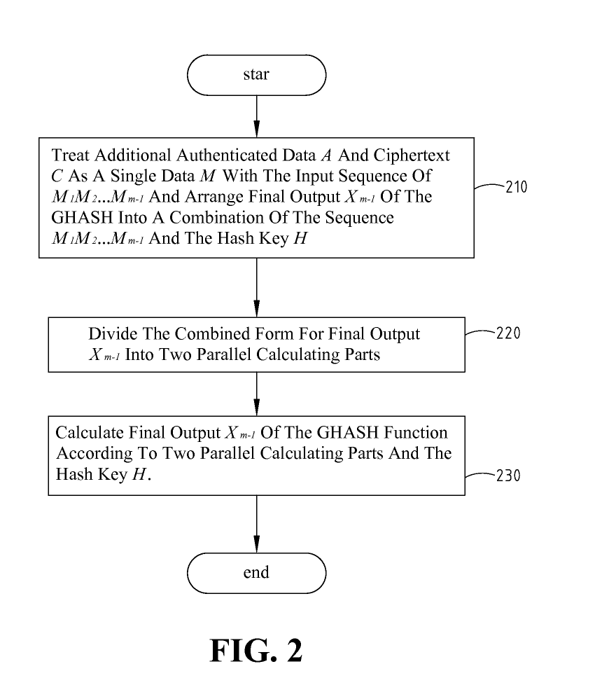

According to the above description, FIG. 2 shows an exemplary flowchart of the method for parallel calculating GHASH of GCM, consistent with certain disclosed embodiments. As shown in step 210, AAD A and ciphertext C are treated as a single data M with the input sequence of M₁M₂ . . . Mₘ₋₁, and final output Xₘ₋₁ of the GHASH is arranged into a combination of the sequence M₁M₂ . . . Mₘ₋₁ and the power of hash key H, where m−1 is the total block length of single data M. In step 210, equation (3) is the combination of the sequence M₁M₂ . . . Mₘ₋₁ and the hash key H.

In step 220, the combined form for final output Xₘ₋₁ is further divided into two parallel calculating parts, X_{O} and X_{E}. In step 220, X_{O} is the sum of all the items of H with odd exponential, and X_{E} is the sum of all the items of H with even exponential, as shown in equation (4) and equation (5).

After two parallel calculating parts X_{O} and X_{E} are computed, as shown in step 230, the final output Xₘ₋₁ of the GHASH function is calculated according to two parallel calculating parts X_{O} and X_{E} and the hash H. In step 230, the computation X_{O}·H⊕X_{E} is executed to calculate the final hash value, where ⊕ is the GF(2ⁿ) addition.

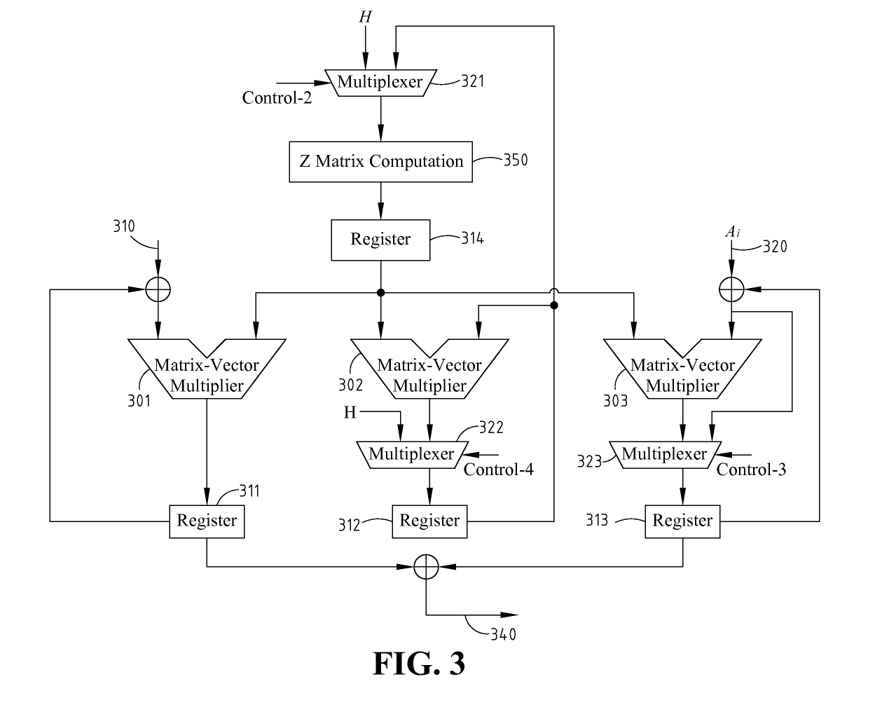

As aforementioned, the exponentials of H corresponding to m−1 being odd and m−1 being even are different. Therefore, when computing even/odd data, the condition can be either with known m−1 or unknown m−1. When m−1 is known, it may be known in advance that odd data M₂ᵢ₋₁ and even data M₂ᵢ belongs to X_{O} or X_{E}, respectively, before being input to the corresponding calculating circuit. FIG. 3 shows a schematic view of an exemplary architecture for parallel calculating GHASH of GCM, when m−1 is known to be either even or odd, consistent with certain disclosed embodiments. The design of GHASH architecture allows either the left side or the right side to calculate X_{O}, and the other side to calculate X_{E}. In the exemplary embodiment of FIG. 3, the left-side circuit is to calculate X_{E}, and the right-side circuit is to calculate X_{O}.

Referring to FIG. 3, the GHASH architecture 300 has three inputs, namely, 310, 320 and H, and an output 340. It can be seen from FIG. 3, GHASH architecture 300 comprises three matrix-vector multipliers 301-303, four registers 311-314, three multiplexers 321-323, and a GF(2^{k}) adder ⊕.

One of four registers 311-314, for example, register 312, stores the H value and H² value at different clocks, another register, for example, register 314, stores the Z-matrix of H and H² at different clocks, and the remaining two registers, for example, registers 311, 313, store the intermediate values of two parallel calculating parts X_{O} and X_{E}. A Z-matrix computation 350 and three matrix-vector multipliers 301-303 are used to realize three GF(2^{k}) multipliers for computing two parallel calculating parts X_{O} and X_{E} and H² value, respectively. Three multiplexers 321-323 make proper selections through three control signals control-2, control-3, and control-4.

After computing two calculating parts X_{O} and X_{E} and selecting H value, hash value X_{O}H+X_{E} of the GHASH computation may be obtained through adder ⊕; that is, output 340 of GHASH architecture 300.

The initial values of register 311 and register 313 are the identity zero of the GF(2^{k}) addition, and the initial values of register 312 and register 314 are the identity one of the GF(2^{k}) multiplication. GF(2^{k}) addition ⊕ may be implemented with XOR gate or software modules.

Because the last item of X_{E} is still multiplied by H², there is no need to have a multiplexer before register 311, as shown in FIG. 3. The circuit to calculate X_{E} and the circuit to calculate X_{O} may be regarded as two independent circuits. The details of GHASH architecture are further described as follows.

In step 1, control signal control-2 selects H value, and stores the calculated Z-matrix value to register 314 through Z-matrix computation; control signal control-4 selects H value and stores to register 312. In step 2, control signal control-4 selects matrix-vector multiplier 302 and stores H² in register 312. In step 3, control signal control-2 selects register 312, and stores the Z-matrix value of H² in register 314.

From step 4 to step [(m−1)/2], where [•] is a ceiling function, X_{E} and X_{O} are calculated separately and stored in register 311 and register 313, respectively. In step [(m−1)/2], the value stored in register 313 must be noticed; that is, the right side circuit for calculating X_{O} must use control signal control-3 to select register 313 and the output of input 320 with ⊕ computation. Therefore, the parallel calculation of X_{E} and X_{O} only takes [(m−1)/2]−3 steps.

In step [(m−1)/2]+1, control signal control-2 selects H value and stores the Z-matrix value of H in register 314. In step [(m−1)/2]+2, X_{O}H⊕X_{E} may be outputted. Therefore, in using GHASH architecture of FIG. 3, when the total number of the data of AAD A and ciphertext C defined in GCM specification is m−1, the m−1 data may be treated as a single data M with an input sequence of M₁M₂ . . . Mₘ₋₁. By inputting data M in the even/odd manner, the number of calculation steps may be reduced to about [m/2]. Hence, the disclosed exemplary embodiments may provide parallel calculation for the odd-order input data and even-order input data.

The calculation of X_{E} may be implemented with a register, a matrix-vector multiplier and a GF(2^{k}) adder ⊕, and combined with a control signal to select, where k is a natural number. Similarly, the calculation of X_{O} may be implemented with a register, a matrix-vector multiplier and a GF(2^{k}) adder ⊕, and combined with a control signals to select. The calculation of H and H² may be implemented with a Z-matrix computation and two control signals to select. The preferred matrix-vector multiplier may be realized with the base multiplier of Mastorvito's standard defined in GF(2^{k}).

According to the present invention, if the bit length m−1 of the input data can only be known prior to the end of the data, instead of known before transmitting Mᵢ, the GHASH architecture may further include an additional multiplexer with a control signal to make selections. This also simplifies the computation steps to [m/2] steps. Furthermore, in the GHASH architecture, if it is fixed to select the matrix-vector multiplier, another application mode may be used. Another application mode is to treat the AAD and the ciphertext as two separate data, and input in parallel for computation.

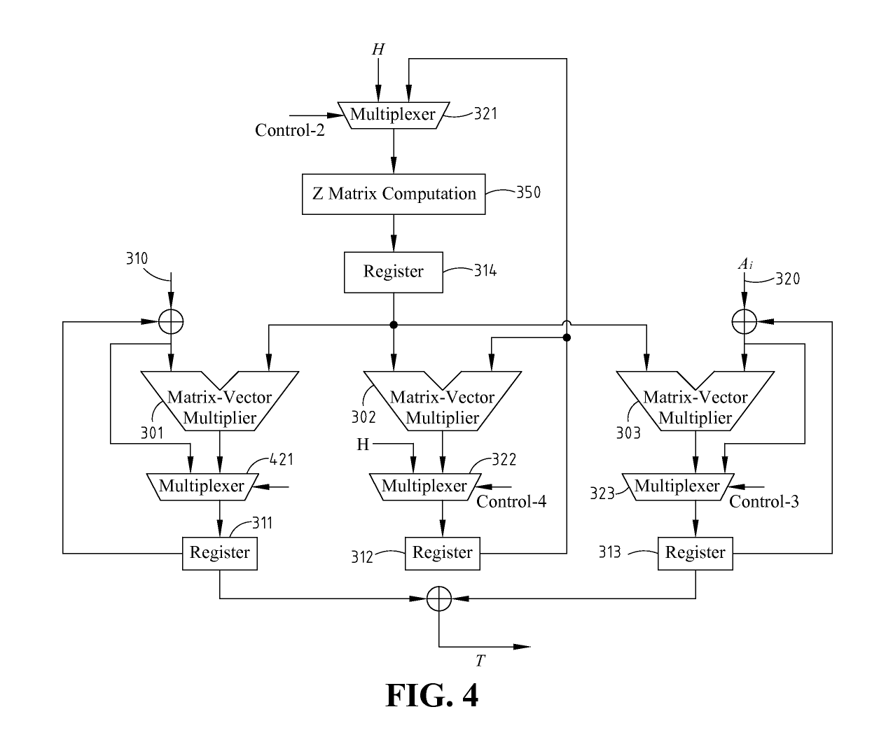

If the value of m−1 can only be known just before the end of the data, instead of before transmitting Mᵢ, the architecture for parallel calculating GHASH is as shown in FIG. 4. It may be seen from FIG. 4, the left and right circuits for calculating X_{E} and X_{O} are symmetric. Hence, the circuit on either side may be selected to calculate X_{O}, and the other side to calculate X_{E}. Assume that the left circuit calculates X_{E}, and the right circuit calculates X_{O}. Compared to the GHASH architecture in FIG. 3, the right circuit for calculating X_{O} requires an additional multiplexer 421 before register 311 and a control-signal control-1 to make a selection. The details of GHASH architecture 400 of FIG. 4 are further described as follows.

Step 1 to step 3 of GHASH architecture 400 are the same step 1 to step 3 of GHASH architecture 300, and thus are omitted here.

From step 4 to step [(m−1)/2]−1, the left circuit of GHASH architecture 400 calculates

$${M}_{1} {H}^{m - 3} ⊕ {M}_{3} {H}^{m - 5} ⊕ … ⊕ {M}_{[ \frac{m - 1}{2} ] \times 2 - 1} {H}^{2}$$

and the right circuit of GHASH architecture 400 calculates

$${M}_{2} {H}^{m - 3} ⊕ {M}_{4} {H}^{m - 5} ⊕ … ⊕ {M}_{[ \frac{m - 1}{2} ] \times 2} {H}^{2} .$$

In step [(m−1)/2], if m−1 is odd, multiplexer 421 selects register 311 and input 310 after the computation of ⊕ through control signal control-1. Control signal control-3 remains the same so as to obtain M₁H^{m-3}⊕M₃H^{m-5}⊕ . . . ⊕Mₘ₋₃H²⊕Mₘ₋₁ and store in register 311. On the other hand, the value in register 313 remains as M₂H^{m-3}⊕M₄H^{m-5}⊕ . . . ⊕Mₘ₋₂H². If m−1 is even, register 313 and input 320 after the computation of ⊕ are selected through control signal control-3. Control signal control-1 remains the same so as to input the next data. Register 311 obtains X_{E} and register 313 obtains X_{O}. Therefore, the parallel calculation of X_{E} and X_{O} only takes [(m−1)/2]−3 steps.

The operations of step [(m−1)/2]+1 and step [(m−1)/2]+2 are the same as in GHASH architecture 300 of FIG. 3, and are omitted here. According to the above, GHASH architecture 400 of FIG. 4 may also simplify the number of calculation steps to about [m/2].

Therefore, in the above embodiments of the present invention, AAD A and ciphertext C defined in GCM specification are arranged as a single data M of an input sequence M₁M₂ . . . Mₘ₋₁, inputted in the odd/even manner. In addition, the hash value Xₘ₋₁ of the GHASH function is simplified as X_{O}H+X_{E}, where X_{O} is the sum of all the items of H having odd exponential, and X_{E} is the sum of all the items of H having even exponential. Because X_{E} and X_{O} have the same computational structure, and may both be simplified to the form of Xᵢ=(Mᵢ⊕Xᵢ₋₁)H², either GHASH architecture of FIG. 3 or GHASH architecture of FIG. 4 may be used for the calculation. It is worth noting that H has different exponentials for m−1 being odd or m−1 being even.

If control signals control-1, control-3 and control-4 are fixed to select matrix-vector multiplier, separate applications for calculating AAD and ciphertext may be executed. In other words, another application mode may treat AAD and ciphertext as two separate data, and inputted in parallel. Therefore, the disclosed exemplary embodiments may provide parallel calculating capability of the AAD and the ciphertext. If the block length of AAD is m₁ and the block length of ciphertext is m₂, the number of calculation steps is about max{m₁,m₂}+1.

In summary, disclosed exemplary embodiments in accordance with the present invention may provide a method and architecture for parallel calculating GHASH of Galois Counter Mode. The GHASH architecture may execute the application in which the AAD with block length m₁ and ciphertext with block length m₂ are treated as a single data and inputted in even/odd parallel manner, or the application in which AAD and ciphertext are calculated separately.

The present invention is applicable to the application areas using GCM mode such as MACsec, EPON, storage devices, or IPsec, for providing applications of data confidentiality.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for parallel calculating GHASH of GCM, for providing applications of data confidentiality, said GHASH function having three inputs, namely, additional authenticated data A and ciphertext C defined in said GCM, and HASH key H of said GHASH function, said method comprising:
treating said additional authenticated data A and said ciphertext C as a single data M of an input sequence M₁M₂ . . . Mₘ₋₁, and arranging the final output Xₘ₋₁ of said GHASH function as a combination of said input sequence M₁M₂ . . . Mₘ₋₁ and one or more exponentials of said H, where m−1 being the block length of said single data M, m being an integer larger than 1;
dividing said final output Xₘ₋₁ into two parallel calculating parts; and
computing said HASH value of said GHASH function according to said two parallel calculating parts and H value.

2. The method as claimed in claim 1, wherein a first part of said two parallel calculating parts is the sum of all the items in said combined Xₘ₋₁ of which the exponential of H is even, and a second part of said two parallel calculating parts is the sum of all the items in said combined Xₘ₋₁ of which the exponential of H is odd.

3. The method as claimed in claim 2, wherein said HASH value of said GHASH function is obtained through computing X_{O}·H⊕X_{E}.

4. The method as claimed in claim 3, wherein said ⊕ is the Galois Field addition.

5. The method as claimed in claim 1, wherein m−1 is even, X_{E} is the sum of all the items M₂ᵢ₋₁, and X_{O} is the sum of all the items M₂ᵢ, where 1≦i≦m−1.

6. The method as claimed in claim 1, wherein when m−1 is odd, X_{E} is the sum of all the items M₂ᵢ, and X_{O} is the sum of all the items M₂ᵢ₋₁, where 1≦i≦m−1.

7. The method as claimed in claim 1, wherein the number of steps required for calculating said two parallel calculating parts is [(m−1)/2]−3 steps, where [•] is a ceiling function.

8. An architecture for parallel calculating GHASH of GCM, for providing applications of data encryption, said GHASH function having inputs of additional authenticated data, ciphertext defined in said GCM, and HASH key H of said GHASH function, said architecture comprising:
three multipliers, for calculating two parallel calculating parts and H² value, respectively;
four registers, one of said four registers storing H value and H² value at two different clocks, another register storing a Z matrix value of H and H² at two different clocks, and two remaining registers storing intermediate values of said two parallel calculating parts; and
three multiplexers, for making different selections through control of different control signals;
where after calculating said two parallel calculating parts and selecting H through a Galois Field addition ⊕, said HASH value of said GHASH function is obtained.

9. The architecture as claimed in claim 8, wherein said three multipliers are realized with a Z matrix computation and three matrix-vector multipliers.

10. The architecture as claimed in claim 8, wherein said Galois Field addition D is realized by either XOR gate or software module.

11. The architecture as claimed in claim 8, wherein when the lengths of said additional authenticated data and ciphertext are unknown, said architecture further includes a multiplexer with another control signal for selecting.

12. The architecture as claimed in claim 8, wherein said architecture provides an operation mode of treating said additional authenticated data and ciphertext as a single input data, and parallel inputting said single input data in even/odd manner for calculation.

13. The architecture as claimed in claim 8, wherein said architecture provides another operation mode of treating said additional authenticated data and ciphertext as two separate input data, and parallel inputting for calculation.

14. The architecture as claimed in claim 8, wherein said two parallel calculating parts have the same computational structure.

15. The architecture as claimed in claim 14, wherein said two parallel calculating part are calculated through a register, a matrix-vector multiplier, said Galois Field addition ⊕ and at least a control signal.

16. The architecture as claimed in claim 9, wherein said three matrix-vector multipliers are implemented with three based multipliers of Mastorvito's standard defined in a Galois Field.

17. The architecture as claimed in claim 8, wherein H value and H² value are obtained through a register, a Z matrix computation and two control signals.
